(19) United States
(12) Patent Application Publication
(10) Pub. No.: US 2011/0204661 A1
(43) Pub. Date: Aug. 25, 2011

(54) SWING GATE HOLD-BACK DEVICE

(76) Inventor: David A. Harroun, Frankfort, IL (US)

(21) Appl. No.: 13/034,702

(22) Filed: Feb. 25, 2011

Related U.S. Application Data
(60) Provisional application No. 61/307,945, filed on Feb. 25, 2010.

(51) Int. Cl. E05C 19/00

(52) U.S. Cl. 292/253

(57) ABSTRACT

A swing gate hold-back device for releasably retaining a gate frame having a horizontal rail in an open position relative to a fixed vertical gate post includes a main body member having a first elongated L-shaped arm, a second elongated L-shaped arm, and a strap mount plate member. Each of the first and second elongated arms are secured at their first ends to the strap mount plate member and are disposed in a spaced apart relationship to each other so as to form a channel therebetween. A V-shaped flapper is pivotally disposed in the channel between the first and second elongated L-shaped arms of the body member for rotating back and forth between a first position corresponding to where the gate frame is in a closed position and a second position corresponding to where the gate frame is in the open position. A U-bolt is used for tightly mounting to the strap mount plate member so as to retain the body member in a desired position on the gate post.

### CROSS-REFERENCE TO RELATED APPLICATIONS

This application is a non-provisional application which claims the benefits of provisional application Ser. No. 61,307,945 filed on Feb. 25, 2010.

### BACKGROUND OF THE INVENTION

1. Technical Field

This invention relates generally to gate latching mechanisms. More particularly, it relates to a swing gate hold-back device for releasably retaining a fence or gate frame in an open position of an improved design and performance.

2. Prior Art

As is generally known in the art, there exist various types of fences or gates having different gate latches employed in the fences which are used to delineate property boundaries and to restrict either access to or egress out of private properties or restricted areas. Some of the numerous types of gates or fences include the chain-link type gates, wood gates, vinyl gates, commercial and industrial pipe barrier gates, pipe frame gates, wrought iron gates and any other suitable enclosures, such as garbage areas. In particular, the popular type chain-link fences typically include a matrix or web of interwoven wires defining square or diamond-shaped openings. This matrix is supported in a substantially vertical orientation by a plurality of fence posts that are embedded in the ground at predetermined spaced intervals.

A portion or section of the chain-link fence includes a gate frame which is hingedly secured to a fence post at its one end and its free end is swingable so as to move the gate frame between a closed position and an open position. Further, the gate frame on the chain-link type fences generally include at least a first horizontal cross member or rail located near the bottom end of the gate frame, a second horizontal rail located near the top end of the gate frame, and a third horizontal rail located substantially in the middle of the gate frame between the top and bottom ends thereof.

A conventional gate latching mechanism 100 for a securing a chain-link fence is known heretofore, which is sometimes referred to as a duckbill-type hold-back mechanism, which requires a separate or additional short pipe or post 102 to be embedded in the ground, pavement, or other foundation at or near the edge of the pathway leading away from the opening of the gate frame 104, as depicted in FIG. 1. This duckbill-type hold-back mechanism 100 is mounted near the lower end of the pipe 102. This prior art gate latching mechanism 100 of FIG. 1 is illustrated in an enlarged manner in FIG. 2 and has been labeled as “PRIOR ART”.

One of the disadvantages of the prior art device of FIGS. 1 and 2 is that it is hazardous or unsafe to people since a person walking in the area would be in danger of tripping on the short post 102 and thus causing injury to themselves. Further, another disadvantage is that the short post may be commonly damaged or destroyed by a motor vehicle when driven past the gate frame. In addition, the gate latching mechanism 100 also have the shortcomings of increased time and expense of added material and higher labor cost for installing the same. For instance, there would be involved the need of digging an additional hole in the ground, removing any asphalt or cement from the pavement, installing the post, and permanently securing the post by using concrete or the like.

Therefore, it would be desirable to provide a swing gate hold-back device for releasably retaining a fence frame in an open position on a more efficient and effective basis. Further, it would be expedient that the hold-back device is durable and simple in its construction, is easy to install and maneuver, and overcomes all of the afore-mentioned shortcomings of the prior art. The present invention represents a significant improvement over the aforementioned prior art gate latching mechanism 100 of FIGS. 1 and 2.

### BRIEF SUMMARY OF THE INVENTION

Most fences or gates generally do not have a built-in gate latching mechanism. The swing gate hold-back device of the present invention is adaptable to numerous fence or gate applications for a multitude of applications. For example, the present device may be used on chain-link type gates, wood gates, vinyl gates, commercial and industrial pipe barrier gates, pipe frame gates, wrought iron gates and any other suitable enclosures, such as garbage areas. The present device provides a swing gate hold-back device or assembly for releasably securing a gate frame in an open position for a multitude of different types of gates or fences.

In view of the foregoing background, it is therefore an object of the present invention to provide a swing gate hold-back device for releasably retaining a gate frame in an open position of improved design and performance. It is another object of the present invention to provide a swing gate hold-back device which is durable and simple in its construction. It is still another object of the present invention to provide a swing gate hold-back device which is easy to install and maneuver, but yet overcomes the disadvantages of the prior art. These and other objects, features and advantages of the invention are provided by a swing gate hold-back device for releasably retaining a gate frame having a horizontal rail in an open position relative to a fixed vertical gate post which includes a main body member being formed of a first elongated L-shaped arm, a second elongated L-shaped arm, and a strap mount plate member. The first L-shaped arm has a longer member and a shorter member joined integrally to the longer member thereof. The second L-shaped arm has a longer member and shorter member joined integrally to the longer member thereof.

Advantageously, the strap mount plate member of the present invention further has a substantially U-shaped intermediate section, a first end section formed integrally with one end of the intermediate section, and a second end section formed integrally with the other end of the intermediate section. Each of the first and second end sections are provided with slotted holes.

Further, each of the shorter members of the first and second L-shaped arms of the body member has its free end thereof secured to the intermediate section of the plate member. The first and second L-shaped arms of the body member are disposed in a spaced apart relationship so as to form a channel therebetween.

In addition, each of the longer members of the first and second L-shaped arms has a gate-stop hole, a pivot hole, a first flapper retainer hole, and a second flapper retainer hole. The gate-stop hole, the pivot hole, the first flapper retainer hole, and the second flapper retainer hole on the longer member of the first L-shaped arm are aligned with the respective gate-stop hole, pivot hole, first flapper retainer hole and second flapper retainer hole on the longer member of the second L-shaped arm.

Advantageously, the present invention further includes a substantially V-shaped flapper having a longer leg member and a triangularly-shaped shorter leg member formed integrally with the longer leg member. The flapper has a first flapper pivot hole disposed at the junction of the longer leg member and the shorter leg member and a second flapper pivot hole disposed on the longer leg member at a predetermined distance from the first flapper pivot hole.

Further, the flapper is received in the channel between the first and second L-shaped arms of the body member so that the first flapper pivot hole is aligned with the pivot holes on the first and second L-shaped arms.

The present invention further includes a bolt which is inserted through the pivot hole on the first L-shaped arm, one of the first and second pivot holes on the flapper, and the pivot hole on the second L-shaped arm so as to define a pivot point to allow the flapper to rotate within the channel between a first position corresponding to where the gate frame is in a closed position and a second position corresponding to where the gate frame is in an open position.

The present invention further includes a U-bolt having a first end and a second end. Each of the first and second ends is provided with a threaded portion. The U-bolt is disposed around the gate post with the threaded portion being inserted through the respective slotted holes of the strap mount plate member so as to secure tightly the body member in a desired position.

These and other features and advantages of the disclosed swing gate hold-back device reside in the construction of parts and the combination thereof, the mode of operation and use, as will become more apparent from the following description, reference being made to the accompanying drawings that form a part of this specification wherein like reference characters designate corresponding parts in the several views. The embodiments and features thereof are described and illustrated in conjunction with systems, tools and methods which are meant to exemplify and to illustrate, not being limiting in scope.

### BRIEF DESCRIPTION OF THE SEVERAL VIEWS OF THE DRAWING

FIG. 1 is a fragmentary, perspective view of a conventional duckbill-type latching mechanism used in conjunction with a garbage enclosure gate frame, labeled “Prior Art”;

FIG. 2 is an enlarged, perspective view of the duckbill-type latching mechanism of FIG. 1, being illustrated separate and apart from the short pipe;

FIG. 3 is perspective view of a first embodiment of a swing gate hold-back device, constructed in accordance with the principles of the present invention;

FIG. 4 is an exploded, perspective view of the device of FIG. 3;

FIG. 5 is an exploded, perspective view, similar to FIG. 4, but illustrating the flapper in the inverted position;

FIG. 6 is a fragmentary, perspective view of the device of FIG. 3 mounted for use with a bottom horizontal rail of a gate frame in a closed position;

FIG. 7 is a fragmentary, perspective view of the device of FIG. 3 mounted for use with a bottom horizontal rail of a gate frame in an open position;

FIG. 8 is a fragmentary, perspective view of the device of FIG. 3 mounted for use with a middle horizontal rail of a gate frame in an open position;

FIG. 9 is a fragmentary, perspective view of the device of FIG. 3 mounted for use with a top horizontal rail of a gate frame in an open position;

FIG. 10 is a fragmentary, perspective view, similar to FIG. 7, illustrating a foot-operated operation to release the bottom horizontal rail of a gate frame from the open position; and

FIG. 11 is a perspective view of a second embodiment of a swing gate hold-back device in accordance with the invention.

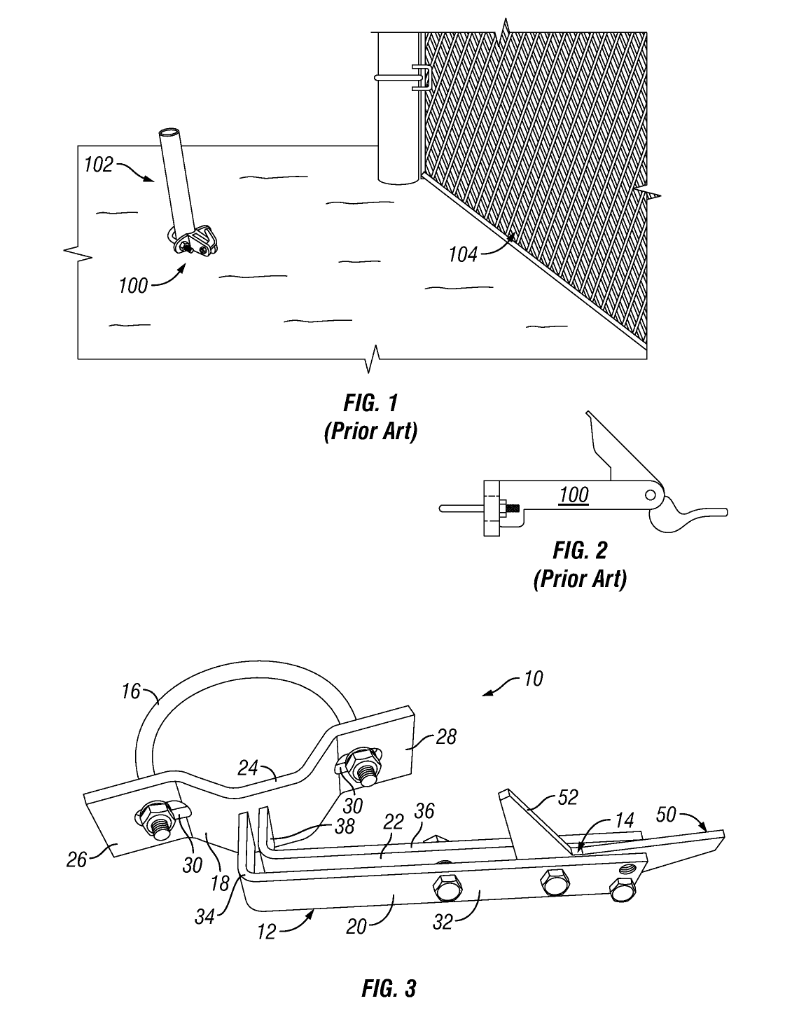

### DETAILED DESCRIPTION OF THE INVENTION

Before explaining the disclosed embodiments in detail, it is to be distinctly understood at the outset that the present invention shown in the drawings and described in detail in association with a swing gate hold-back device for releasably retaining a gate frame in an open position is not intended to serve as a limitation upon the scope or teachings thereof, but is to be considered merely for the purpose of convenience of illustration of one example of its application.

Referring now in detail to the various views of the drawings in FIGS. 3 through 11 of the drawings, there is illustrated a swing gate hold-back device or assembly which is designated generally by reference numeral 10 and is constructed in accordance with the principles of the present invention. The swing gate hold-back device 10 is designed to be of a unique, simplified construction, which is relatively simple to manufacture and assemble.

The gate hold-back assembly 10 is intended to provide a swing gate hold-back mechanism of a unique design for releasably securing a gate frame in an open position for a multitude of different types of fences or gates. It should be clearly understood that the various types of gates include but is not limited to chain-link type gates, wood gates, vinyl gates, commercial and industrial pipe barrier gates, pipe frame gates, wrought iron gates and any other suitable enclosures, such as garbage areas. All of the parts of the assembly 10 may be formed from suitable materials such as metals and hard plastics. The metals include corrosion-resistant aluminum, stainless steel, galvanized steel, and the like.

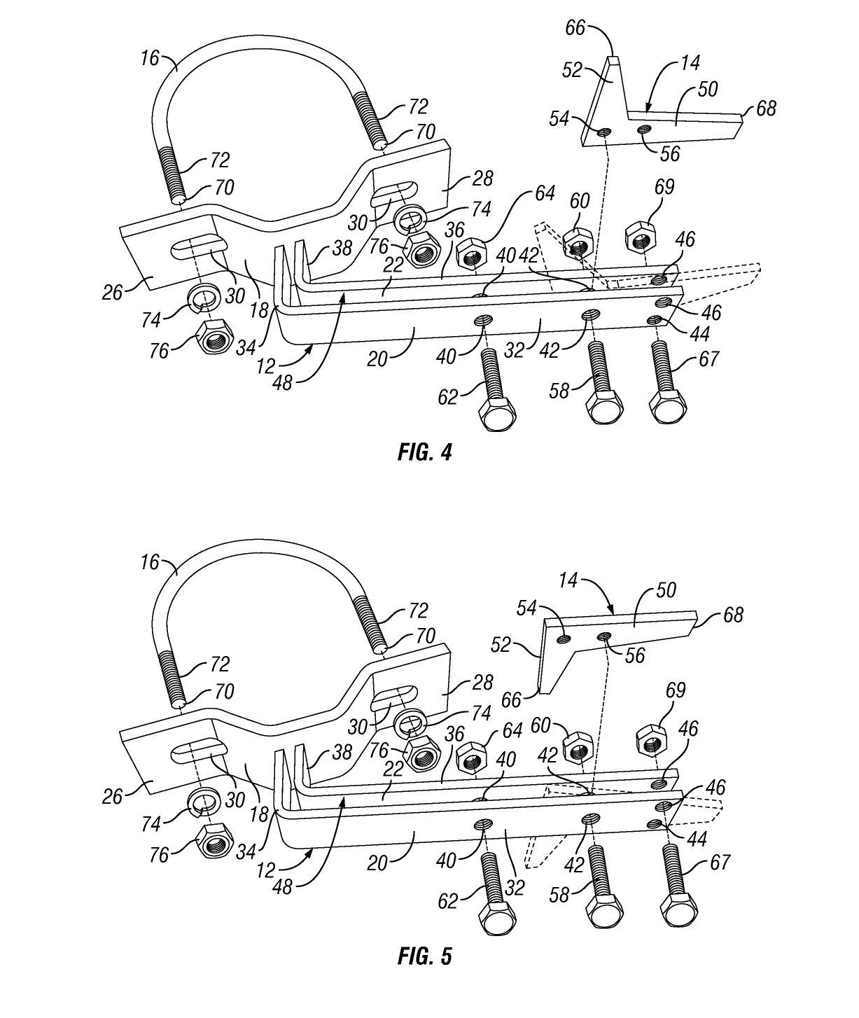

As can be best seen from FIGS. 3 and 4, the swing gate hold-back device 10 of the present invention includes a main body member 12, a substantially V-shaped flapper 14, and a U-shaped bolt 16. The main body member 12 is formed of a strap mount plate member 18, a first elongated L-shaped arm 20, and a second elongated L-shaped arm 22. The strap mount plate member 18 is formed of a rectangular trough-like construction. The plate member includes a substantially U-shaped intermediate section 24, a first end section 26 formed integrally with one end of the U-shaped intermediate section 24, and a second end section 28 formed integrally with the other end of the U-shaped intermediate section 24. Each end of the first and second end sections 26, 28 is formed with a slotted hole 30 used to accommodate different size gate posts. While the strap mount plate member has been illustrated to be rectangular in shape, it should be apparent to those skilled in the art that the plate member may be formed of a square, oval, elliptical, or circular shape as well.

The L-shaped arm 20 includes a longer member 32 and shorter member 34 joined integrally to the longer member 32. Similarly, the L-shaped arm 22 includes a longer member 36 and shorter member 38 joined integrally to the longer member 36. Each of the longer members 32 and 36 is provided with a gate-stop or gate hold retainer hole 40, a pivot hole 42, a first flapper stop or retainer hole 44, and a second flapper stop or retainer hole 46. Each of the shorter members 34, 38 has its free end permanently secured, such as by welding, to the outer surface of the U-shaped section 24 of the strap mount plate member 18. The L-shaped arms 20, 22 are disposed in a spaced apart relationship forming a channel 48 therebetween.

It will be noted that the holes 40 through 46 on the respective longer members 32 and 36 are aligned horizontally with each other. Further, the second flapper stop holes 46 are arranged above the corresponding first flapper stop holes 44 located adjacent the free ends of the longer members 32 and 36. The pivot holes 42 are positioned a predetermined distance from the first and second flapper stop holes 44, 46 and aligned in the intermediate area thereof. The gate-stop holes 40 are positioned a predetermined distance away form the pivot holes 42 in substantially the middle of the longer members 32, 36.

The substantially V-shaped flapper 14 includes a longer leg member 50 and triangularly-shaped shorter leg member 52 formed integrally to the longer leg member 50. A first flapper pivot hole 54 is provided at the junction of the leg members 50 and 52. A second flapper pivot hole 56 is provided in the longer leg member 50 at a predetermined distance from the first flapper pivot hole 54. With particular reference to FIG. 4, it can be seen that the flapper 14 is arranged in the channel 48 between the longer members 32 and 36, as is shown in phantom.

A first bolt 58 is inserted through the pivot hole 42 in the longer member 32 of the first L-shaped arm 20, the pivot hole 54 in the flapper 14, and the pivot hole in the longer arm 36 of the second L-shaped arm 22 so that the longitudinal axis thereof serves as a pivot point about which the flapper 14 pivots. In this manner, the first bolt allows the flapper to pivot or rotate within the channel 48 between the longer arms 32 and 36, thereby permitting the gate frame to swing back and forth between a first position corresponding to where the gate frame is closed and a second position corresponding to where the gate frame is open. A nut 60 is used to lock the free end of the bolt 58.

A second bolt 62 is inserted through the gate-stop holes 40 in the first and second longer members 32 and 36. A second nut 64 is used to lock the free end of the bolt 62. The second bolt 62 serves as an end stop for the flapper gate-hold or retainer end 66 to discontinue the travel thereof and to prevent it from pivoting out of position during normal use. A third bolt 67 is inserted through the retainer holes 44 in the first and second longer members 32 and 36. A third nut 69 is used to lock the free end of the bolt 67. The third bolt 67 serves as an end stop for the flapper release end 68 to discontinue the travel thereof and to prevent it from pivoting out of position during normal use.

The U-shaped bolt or U-bolt 16 is dimensioned to suitably wrap around fixed, vertical gate posts of various outer diameter sizes, such 3, 3½, and 4 inches and to tightly secure the strap mount plate member 18 of the main body member 12 in a desired vertical position on the gate post. Each end 70 of the U-bolt 16 is provided with a threaded portion 72 which is inserted through the respective slotted holes 30 of the plate member 18. A lock washer 74 and a nut 76 defining tightening means are attached to each end 70 of the U-bolt so as to tighten the same around the gate post.

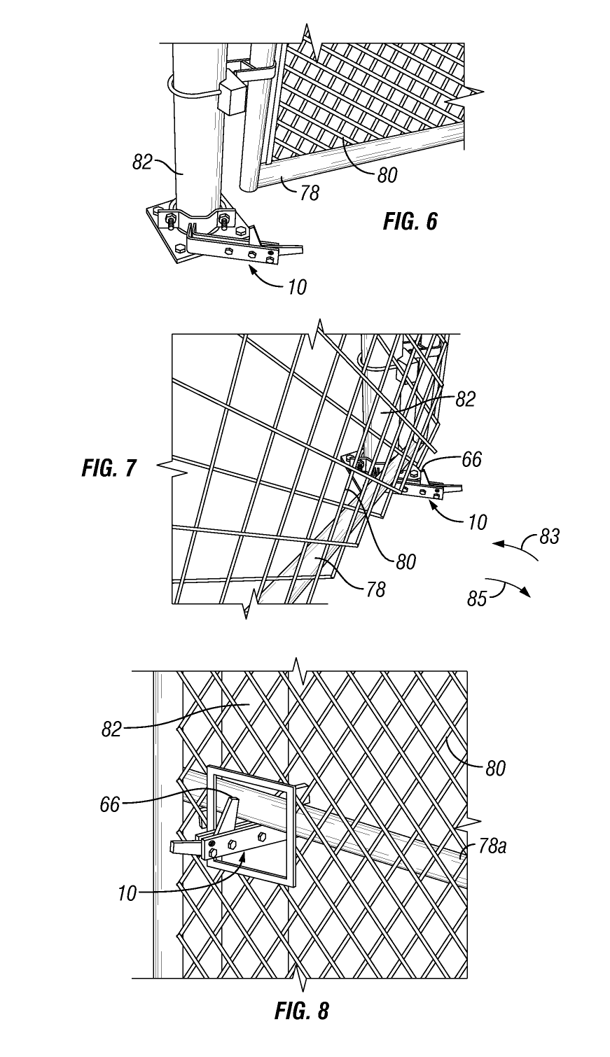

The swing gate hold-back device 10 of FIGS. 3 and 4 has specific applications for in conjunction with a bottom horizontal cross member or rail 78 of a gate frame 80, as shown in FIGS. 6 and 7. FIG. 6 illustrates the device 10 of the present invention mounted adjacent to the bottom end of a fence post 82 in the first or closed position. FIG. 7 illustrates the device 10 of the present invention mounted adjacent to the bottom end of a fence post 82 in the second or open position.

It will be noted that the swing gate hold-back device 10 in FIG. 6 can be adjustably mounted at different positions around the fence post 82 so as to accommodate the various amounts of open area desired when moving the gate frame 80 away from the gate opening. The device 10 is mounted in this lower position on the gate post 82 so that the side of the horizontal rail 80 contactly engages and is held by the underneath side of the flapper gate-stop end 66.

In order to move the gate frame 80 from the closed position (FIG. 6) to the open position (FIG. 7), an operator or user would swing the gate frame 80 towards the device 10 so as to cause the bottom horizontal rail 78 to slide over the flapper release end 68 of the longer leg member 50 of the flapper 14 and then to push downwardly on the shorter leg member 52 thereof. In this manner, the flapper 14 is pivoted in a counter-clockwise direction, as indicated by the arrow 83, about the pivot point. As the horizontal rail 78 passes over the flapper gate-hold end 66 of the shorter leg member 52 of the flapper 14, the flapper due to gravity will rotate back in a clockwise direction, as indicated by the arrow 85. As a result, the horizontal rail 78 is latched or held in the open position of FIG. 7 by the underneath side of the shorter leg member 52 of the flapper contactly engaging the side of the horizontal rail 78.

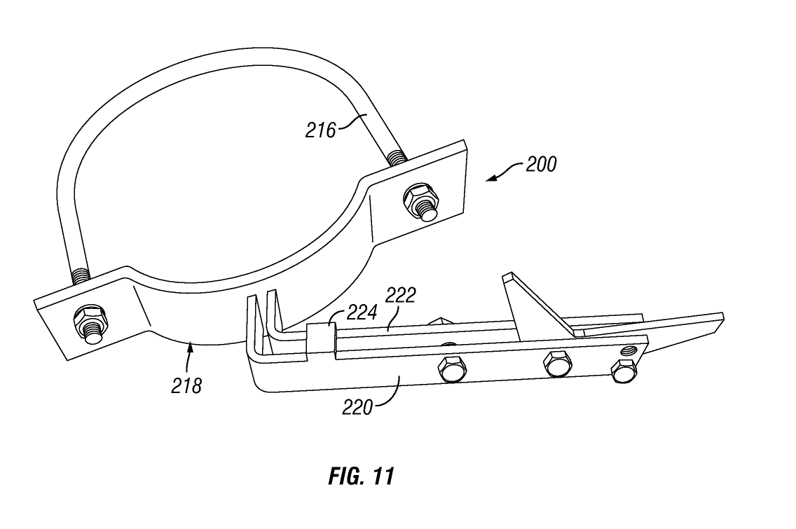

With reference to FIG. 10, when it is desired to release the gate frame from its hold or open position and return it to its closed position (FIG. 6), the user would use his foot 87 to lift upwardly the underneath side of the flapper release end 68 of the longer leg member 50 of the flapper 14. In this manner, the flapper is pivoted initially in the counter-clockwise direction and then in the clockwise direction so as to permit the bottom horizontal rail 78 to slide along the shorter leg member 52 and then along the longer leg member 50 of the flapper 14. As the horizontal rail 78 passes over the flapper release end 68, the gate frame 80 can then be moved back to the closed position and the flapper will due to gravity remains back in its original position.

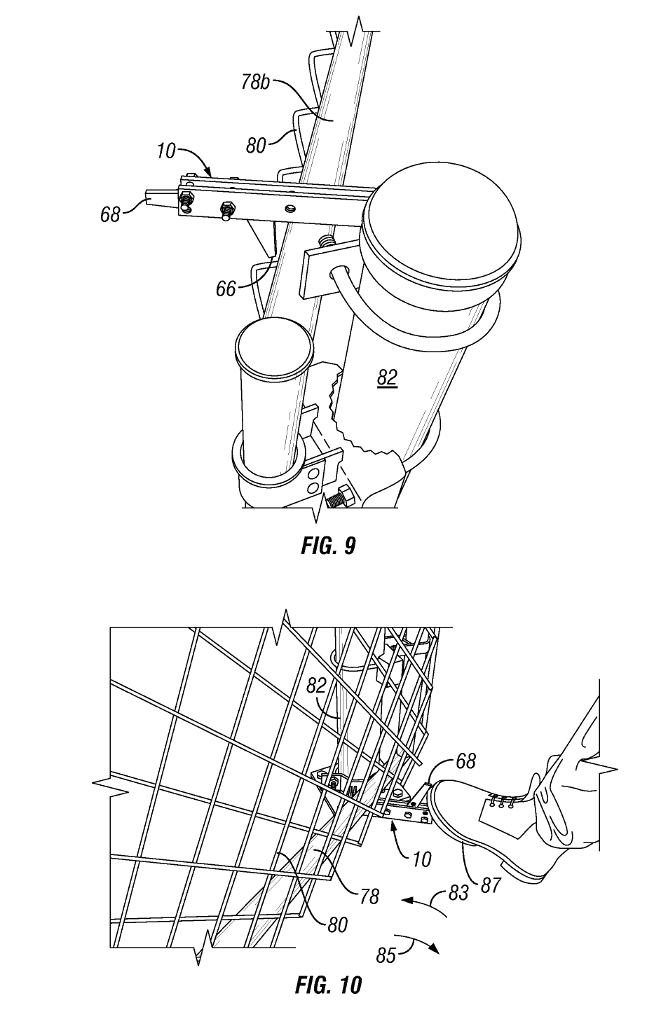

While the device 10 is shown in FIGS. 3, 4, 6, 7 and 10 for use with the bottom horizontal rail of the gate frame, this device 10 can also be employed in conjunction with a middle horizontal rail 78a, as is illustrated in FIG. 8. However, when an application requires the device 10 to be used with a top horizontal rail 78b of the gate frame of FIG. 9, there are some minor adjustment that must be made to the components of the device.

As can be best from FIG. 5, it is necessary to remove all of the nuts and bolts from the main body member. Then, the flapper is lifted out of the channel. Next, the flapper is inverted 180 degrees from its position shown in FIG. 4 and is then re-inserted into channel. The first bolt 58 is inserted through the pivot hole 42 in the first arm 20, the second flapper pivot hole 56, and the pivot hole 42 in the second arm 22. The first nut 60 is secured to the first bolt 58. Further, the third bolt 67 is inserted through the second flapper release holes 46 in the first and second arms 20, 22. The third nut 69 is secured to the third bolt 67. It will noted that the second bolt 62 and second nut 64 are not necessary in this particular application.

The operation of the device 10 in FIGS. 5 and 9 is quite similar to the above discussion with respect to the device of FIGS. 3 and 4, except that in order to return the gate frame to the closed position the release end 68 of the flapper 14 is pushed downwardly with a user's hand (not shown) rather than being pulled or lifted upwardly by the user's foot so to move the top horizontal rail 78b of the gate frame underneath and past the gate-hold end 66 of the flapper 14.

In FIG. 11, there is depicted a second embodiment of a swing gate hold-back device 200 in accordance with the invention. The construction of the device 200 is substantially identical to the device of FIG. 3, except that the strap mount plate member 218 is made larger and straighter with a different radius so as to accommodate a larger diameter gate post, such as 6⅝ inches. In addition, the U-bolt 216 is made larger so match the plate member 218. A weld spot 224 is used to secured together the first and second L-shaped arms 220 and 222. Since the other components and their operation are identical to those described with respect to FIGS. 3 and 4, a detail discussion is believed to be not necessary.

From the foregoing detailed description, it should be clearly understood that the optimum dimensional relationship for the particular elements or components of the present invention may include variations in size, material, shape, form, function, and manner of operation. Further, the swing gate hold-back device of the invention can be readily formed by conventional fabrication techniques such stamping, punching, bending, welding and the like. The present device is able to universally interact with either a bottom, middle, or top horizontal cross member or rail of a gate frame so as to hold open the gate frame and to close the same by a user's foot or hand. The device may be mounted directly on gate posts of either single or double gates and is adaptable to be mounted either under or above the horizontal rail of the gate frame. The present invention can be quickly installed onto a gate post at any vertical position as long as a horizontal rail is present at approximately the same height, thereby requiring less labor and thus reducing total cost.

While there has been illustrated and described what is at present considered to be a preferred embodiment of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiment disclosed as the best mode contemplated for carrying out the invention, but that the invention will include all embodiments falling within the scope of the appended claims.

1. A swing gate hold-back device for releasably retaining a gate frame having a horizontal rail in an open position relative to a fixed vertical gate post, comprising:
a main body member being formed of a first elongated L-shaped arm, a second elongated L-shaped arm, and a strap mount plate member, said first L-shaped arm having a longer member and a shorter member joined integrally to said longer member thereof, said second L-shaped arm having a longer member and shorter member joined integrally to said longer member thereof;
said strap mount plate member having a substantially U-shaped intermediate section, a first end section formed integrally with one end of said intermediate section, and a second end section formed integrally with the other end of said intermediate section, each of said first and second end sections being provided with slotted holes;
each of said shorter members of said first and second L-shaped arms of said body member having its free end thereof secured to said intermediate section of said plate member, said first and second L-shaped arms of said body member being disposed in a spaced apart relationship so as to form a channel therebetween;
each of said longer members of said first and second L-shaped arms having a gate-stop hole, a pivot hole, a first flapper retainer hole, and a second flapper retainer hole, said gate-stop hole, said pivot hole, said first flapper retainer hole, and said second flapper retainer hole on said longer member of said first L-shaped arm being aligned with the respective gate-stop hole, pivot hole, first flapper retainer hole and second flapper retainer hole on said longer member of said second L-shaped arm;
a substantially V-shaped flapper having a longer leg member and a triangularly-shaped shorter leg member formed integrally with said longer leg member, said flapper having a first flapper pivot hole disposed at the junction of said longer leg member and said shorter leg member and a second flapper pivot hole disposed on said longer leg member at a predetermined distance from said first flapper pivot hole;
said flapper being received in said channel between said first and second L-shaped arms of said body member so that one of said first and flapper pivot holes is aligned with said pivot holes on said first and second L-shaped arms;
a bolt being inserted through said pivot hole on said first L-shaped arm, one of said first and second pivot holes on said flapper, and said pivot hole on said second L-shaped arm so as to define a pivot point to allow said flapper to rotate within said channel between a first position corresponding to where the gate frame is in a closed position and a second position corresponding to where the gate frame is in an open position; and
a U-bolt having a first end and a second end, each of said first and second ends being provided with a threaded portion, said U-bolt being disposed around the gate post with said threaded portion being inserted through the respective slotted holes of said strap mount plate member so as to secure tightly said body member in a desired position.

2. A swing gate hold-back device for releasably retaining a gate frame as claimed in claim 1, wherein a free end of said longer leg member of said V-shaped flapper defines a flapper release end and further including a second bolt being inserted through one of said first and second flapper retainer holes in said first and second L-shaped arms so as to serve as a first end stop for the flapper release end to discontinue its travel and to prevent it from pivoting out of position during use.

3. A swing gate hold-back device for releasably retaining a gate frame as claimed in claim 2, wherein a free end of said shorter leg member of said V-shaped flapper defines a gate-hold end and further including a third bolt being inserted through said gate-stop retainer holes in said first and second L-shaped arms so as to serve as a second end stop for the gate-hold end to discontinue its travel and to prevent it from pivoting out of position during use.

4. A swing gate hold-back device as claimed in claim 3, wherein the horizontal rail of the gate frame is located adjacent to the bottom end of the gate post and is held underneath said gate-hold end of said flapper when the gate frame is in the open position.

5. A swing gate hold-back device as claimed in claim 3, wherein the horizontal rail of the gate frame is located adjacent to the middle of the gate post and is held underneath said gate-hold end of said flapper when the gate frame is in the open position.

6. A swing gate hold-back device as claimed in claim 3, wherein the horizontal rail of the gate frame is located adjacent to the top end of the gate post and is held underneath said gate-hold end of said flapper when the gate frame is in the open position.

7. A swing gate hold-back device as claimed in claim 4, wherein a foot of an operator is used to lift upwardly on the flapper release end of said flapper to release the gate frame from the open position and return it to the closed position.

8. A swing gate hold-back device as claimed in claim 5, wherein a hand of an operator is used to lift upwardly on the flapper release end of said flapper to release the gate frame from the open position and return it to the closed position.

9. A swing gate hold-back device as claimed in claim 6, wherein a hand of an operator is used to push downwardly on the flapper release end of said flapper to release the gate frame from the open position and return it to the closed position.

10. A swing gate hold-back device for releasably retaining a gate frame having a horizontal rail in an open position relative to a fixed vertical gate post, comprising:
body means including a first elongated arm, a second elongated arm, and a strap mount plate member;
each of said first and second elongated arms being secured at their first ends to said strap mount plate member and being disposed in a spaced apart relationship so as to form a channel therebetween;
flapper means pivotally disposed in said channel between said first and second elongated arms of said body means for rotating back and forth between a first position corresponding to where said gate frame is in a closed position and a second position corresponding to where said gate frame is in the open position; and
securing means for tightly mounting to said strap mount plate member so as to retain said body means in a desired position on the gate post.

11. A swing gate hold-back device as claimed in claim 10, wherein said first arm is of a L-shaped construction and has a longer member and a shorter member joined integrally to said longer member thereof and wherein said second arm is of a L-shaped construction and has a longer member and shorter member joined integrally to said longer member.

12. A swing gate hold-back device as claimed in claim 11, wherein said strap mount plate member has a substantially U-shaped intermediate section, a first end section formed integrally with one end of said intermediate section, and a second end section formed integrally with the other end of said intermediate section, each of said first and second end sections being provided with slotted holes.

13. A swing gate hold-back device as claimed in claim 12, wherein each of said longer members of said first and second L-shaped arms has a gate-stop hole, a pivot hole, a first flapper retainer hole, and a second flapper retainer hole, said gate-stop hole, said pivot hole, said first flapper retainer hole, and said second flapper retainer hole on said longer member of said first L-shaped arm being aligned with the respective gate-stop hole, pivot hole, first flapper retainer hole and second flapper retainer hole on said longer member of said second L-shaped arm.

14. A swing gate hold=back device as claimed in claim 13, wherein said flapper means has a substantially V-shaped construction and has a longer leg member and a triangularly-shaped shorter leg member formed integrally with said longer leg member, said flapper having a first flapper pivot hole disposed at the junction of said longer leg member and said shorter leg member and a second flapper pivot hole disposed on said longer leg member at a predetermined distance from said first flapper pivot hole.

15. A swing gate hold-back device as claimed in claim 14, wherein said flapper is received in said channel between said first and second L-shaped arms of said body means so that one of said first and second flapper pivot holes is aligned with said pivot holes on said first and second L-shaped arms.

16. A swing gate hold-back device as claimed in claim 15, wherein a bolt being inserted through said pivot hole on said first L-shaped arm, one of said first and second pivot holes on said flapper, and said pivot hole on said second L-shaped arm so as to define a pivot point to allow said flapper to rotate within said channel between a first position corresponding to where the gate frame is in a closed position and a second position corresponding to where the gate frame is in an open position.

17. A swing gate hold-back device as claimed in claim 16, wherein said securing means includes a U-bolt having a first end and a second end, each of said first and second ends being provided with a threaded portion, said U-bolt being disposed around the gate post with said threaded portion being inserted through the respective slotted holes of said strap mount plate member so as to secure tightly said body member in a desired position.

18. A swing gate hold-back device for releasably retaining a gate frame having a horizontal rail in an open position relative to a fixed vertical gate post, comprising:
body means including channel means being securely mounted in a desired position on the gate post; and
flapper means pivotally disposed in said channel means of said body means for rotating back and forth between a first position corresponding to where said gate frame is in a closed position and a second position corresponding to where said gate frame is in the open position

19. A swing gate hold-back device as claimed in claim 18, wherein said body means includes a main body member being formed of a first elongated L-shaped arm, a second elongated L-shaped arm, and a strap mount plate member, said first L-shaped arm having a longer member and a shorter member joined integrally to said longer member thereof, said second L-shaped arm having a longer member and shorter member joined integrally to said longer member thereof.

20. A swing gate hold-back device as claimed in claim 19, wherein said flapper means has a substantially V-shaped construction and has a longer leg member and a triangularly-shaped shorter leg member formed integrally with said longer leg member, said flapper having a first flapper pivot hole disposed at the junction of said longer leg member and said shorter leg member and a second flapper pivot hole disposed on said longer leg member at a predetermined distance from said first flapper pivot hole.
